(19) United States
(12) Patent Application Publication
(10) Pub. No.: US 2026/0058402 A1
(43) Pub. Date: Feb. 26, 2026

(54) CONNECTOR MATING STRUCTURE

(71) Applicant: Yazaki Corporation, Tokyo (JP)

(72) Inventors: Tomoyoshi FUKAYA, Makinohara-shi (JP); Hiroki KATO, Tokyo (JP)

(73) Assignee: Yazaki Corporation, Tokyo (JP)

(21) Appl. No.: 19/300,004

(22) Filed: Aug. 14, 2025

(30) Foreign Application Priority Data
Aug. 21, 2024 (JP) 2024-139754

(51) Int. Cl. H01R 13/52

(52) U.S. Cl. CPC H01R 13/5219

(57) ABSTRACT

A connector mating structure includes a packing is attached to a female housing of a female connector. The packing includes an annular section and a locked section, the annular section being attached to an outer peripheral surface of a body section and a forward side of a collar, wherein the locked section is connected to the annular section and locked to an opening of the collar. The annular section provides seal between the outer peripheral surface of the body section and an inner peripheral surface of a tubular section of a male housing. The locked section includes an inserted portion and a protrusion, the inserted portion extending backward from a backward end of the annular section and being inserted into the opening, wherein the protrusion protrudes inward into the annular section from a backward end of the inserted portion and is positioned on a backward side of the collar.

### BACKGROUND OF THE INVENTION

### Technical Field

The present invention relates to a connector mating structure including a male connector and a female connector configured to be mated with each other.

### Background Art

A connector mating structure for mating a male connector with a female connector is known in which a packing provides seal between a male housing and a female housing.

Patent Document 1 discloses a connector mating structure which includes a body section with a female housing, wherein the female housing accommodates a female terminal and an annular packing is attached to an outer peripheral surface of the body section. The male housing includes a tubular section which receives the body section of the female housing. In a mated state of the male connector and female connector which are mated with each other, the packing provides seal between the outer peripheral surface of the body section of the female housing and an inner peripheral surface of the tubular section of the male housing.

### CITATION LIST

### Patent Literature

Patent Document 1: JP 2022-7493 A

### SUMMARY OF THE INVENTION

The connector mating structure according to Patent Document 1 is provided in such a manner that the packing is attached to the body section of the female housing in a same direction in which the male connector and female connector are mated with each other and removed from each other. Therefore, the connector mating structure has a problem that during removal operation for releasing the mated state of the male connector and female connector, a friction force is generated by the tubular section of the male housing and the packing, wherein the packing is pulled by the friction force and is thus removed from the body section and/or misaligned.

Therefore, an objective of the present invention is to provide a connector mating structure which enables removal and/or misalignment of a packing to be prevented.

The present invention provides a connector mating structure including: a male connector and a female connector configured to be mated with each other, wherein the male connector includes a male terminal and a male housing, wherein the male housing includes a tubular section surrounding one end of the male terminal, wherein the female connector includes a female terminal, a female housing and a packing, wherein the female housing includes a body section and a collar, wherein the body section is configured to accommodate the female terminal and includes a forward half, the forward half being configured to be inserted into the tubular section, wherein the collar extends outward from an outer peripheral surface of the body section has an opening, wherein the packing includes an annular section and a locked section, wherein the annular section is configured to be attached to the outer peripheral surface of the body section and to a forward side of the collar to provide seal between the outer peripheral surface of the body section and an inner peripheral surface of the tubular section, and wherein the locked section is connected to the annular section and locked to the opening.

The present invention provides a connector mating structure which enables removal and/or misalignment of a packing to be prevented.

### BRIEF DESCRIPTION OF THE DRAWINGS

FIG. 1 shows a front view of a female connector which is part of a connector mating structure according to an embodiment of the present invention;

FIG. 2 shows an exploded view of the female connector according to FIG. 1;

FIG. 3 shows a sectional view along the line A-A according to FIG. 1;

FIG. 4 shows a view which includes only the female housing according to FIG. 3;

FIG. 5 shows a view which includes only a packing according to FIG. 3;

FIG. 6 shows a mated state of the female connector and a male connector according to FIG. 3 which are mated with each other;

FIG. 7 shows an enlarged view of Region C according to FIG. 6;

FIG. 8 shows a mated state of the female connector and a male connector according to FIG. 1, wherein the mated state is shown in a sectional view along the line B-B in FIG. 1;

FIG. 9 shows how the female connector and male connector according to FIG. 6 are removed from each other; and

FIG. 10 shows an enlarged view of Region D according to FIG. 9.

### DETAILED DESCRIPTION OF THE PREFERRED EMBODIMENTS

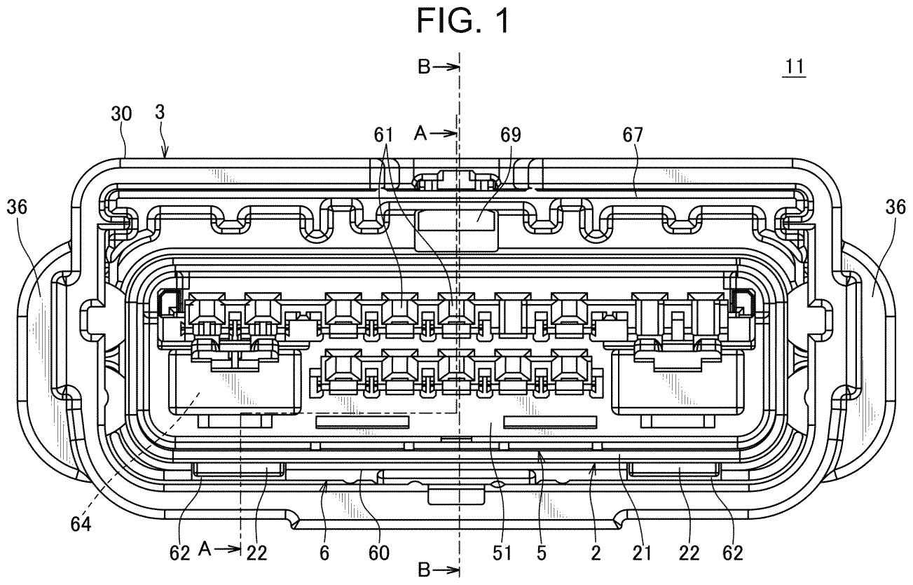

A “connector mating structure” according to an embodiment of the present invention will be described with reference to FIGS. 1 to 10.

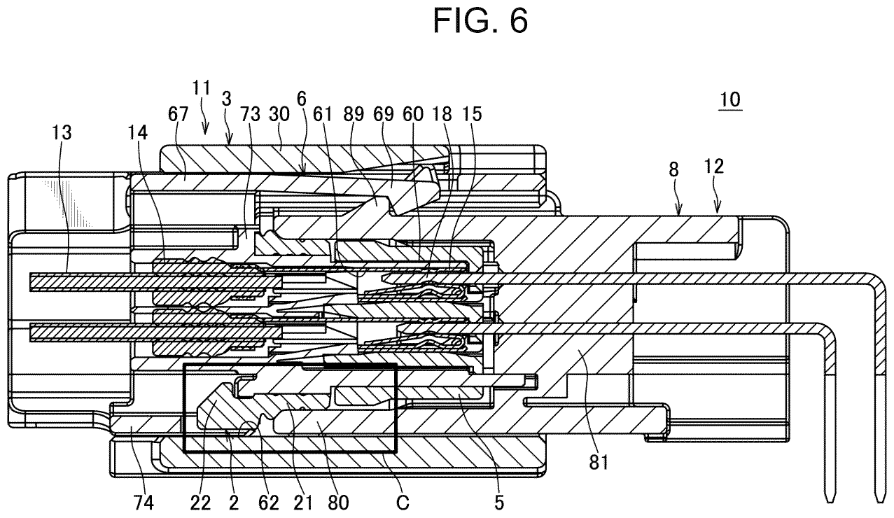

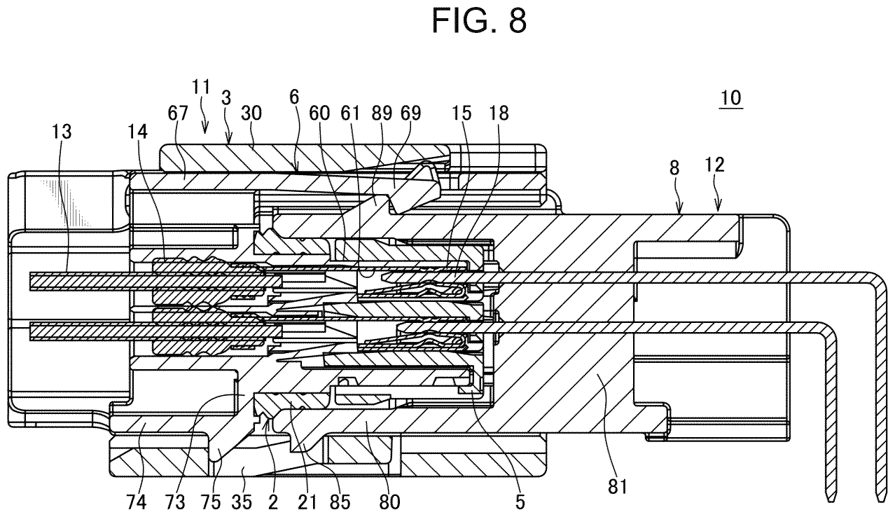

As shown in FIGS. 6 and 8, a connector mating structure 10 includes a male connector 12 and a female connector 11 configured to be mated with each other.

In the present specification, with respect to the male connector 12, one side and an opposite side along a direction of mating of the male connector 12 with the female connector 11 shall be a “forward” side and a “backward” side, wherein the one side is facing the female connector 11. Similarly, with respect to the female connector 11, one side and an opposite side along a direction of mating of the female connector 11 with the male connector 12 shall be a “forward”side and a “backward”side, wherein the one side is facing the male connector 12.

The male connector 12 includes a plurality of male terminals 18 and a male housing 8.

Each of the male terminals 18 has a bar shape, wherein a portion of the bar shape positioned in the male housing 8 extends straight, and a portion of the bar shape positioned outside the male housing 8 is bent at right angle so that the bar shape is generally formed in an L-shape.

The male housing 8 consists of an insulating resin. The male housing 8 includes a terminal holding section 81 and a tubular section 80 formed integrally, wherein the terminal holding section 81 holds the plurality of male terminals 18, and the tubular section 80 surrounds ends of the male terminals 18 on their one side.

The tubular section 80 is opened on its forward side and closed on its backward side by the terminal holding section 81. The tubular section 80 receives a body section 60 of the female housing 6. One or more lock portions 89 are formed on an outer surface of the tubular section 80 to be locked to the female housing 6, wherein one or more lock portions 85 are formed on the outer surface of the tubular section 80 to be locked to an outer housing 3.

As shown in FIGS. 1 to 3, the female connector 11 includes a plurality of female terminals 15, a short-circuit terminal 4, the female housing 6, front retainer 5, the outer housing 3, springs 16 and a packing 2.

Each of the female terminals 15 is connected to an end of an electric wire 13. A rubber plug 14 is attached to each of the electric wires 13. The rubber plugs 14 provide seals between the respective electric wires 13 and walls which define female terminal accommodating chambers 61 as described below. Each of the female terminals 15 includes a quadrilateral tubular section and a spring element arranged inside the quadrilateral tubular section, wherein the quadrilateral tubular section is capable of receiving one end of a male terminal 18.

The short-circuit terminal 4 is configured to come into contact with two adjacent female terminals 15 to short-circuit these female terminals 15 in a non-mated state of the male connector 12 with the female connector 11. When the male connector 12 is mated with the female connector 11, a portion of the male housing 8 is introduced between the short-circuit terminal 4 and the two female terminals 15 to bring the short-circuit terminal 4 out of contact with the two female terminals 15. This brings the two female terminals 15 out of the short-circuited state.

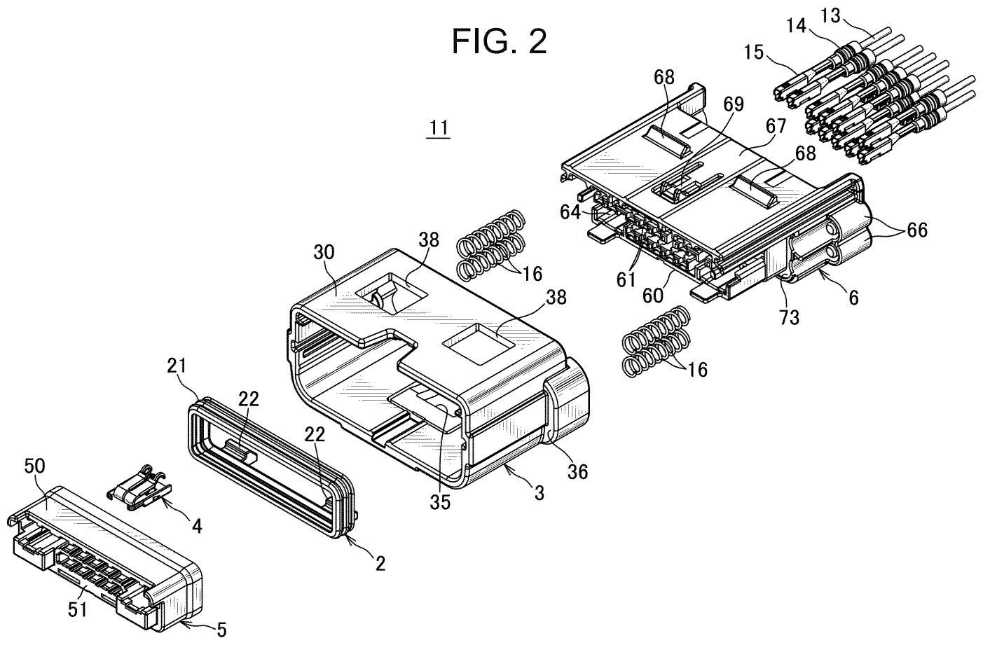

The female housing 6 consists of an insulating resin. As shown in FIGS. 2 and 4, the female housing 6 includes a body section 60, a collar 73, a lower plate section 74, spring accommodating chambers 66, and an upper plate section 67, which are formed integrally.

The body section 60 includes the female terminal accommodating chambers 61, lances 63, and a short-circuit terminal accommodating chamber 64, the female terminals 15 being accommodated in the respective female terminal accommodating chambers 61, wherein the lances 63 are locked to the respective female terminals 1, and the short-circuit terminal 4 is accommodated in the short-circuit terminal accommodating chamber 64. Each of the lances 63 is connected to a wall in a cantilevered manner, wherein the wall defines part of the female terminal accommodating chamber 61. A free end of the lance 63 is locked to a backward end of the quadrilateral tubular section to prevent removal of the female terminal 15. The body section 60 has an outer shape which is rectangular-parallelepiped, wherein the body section 60 has a rectangular shape in a front view. A forward half of the body section 60 is inserted in the tubular section 80.

The collar 73 extends outward from an outer peripheral surface of the body section 60. The collar 73 has two openings 62 for locking locked sections 22 of the packing 2 therein as described below therein. Each of the openings 62 is defined by a quadrilateral recess formed in the collar 73, and is opened on three sides of the collar 73, i.e., on a forward side, a backward side, and a side of the collar 73 facing the outer housing 3 (lower side).

As shown in FIGS. 4 and 8, the lower plate section 74 is arranged below the body section 60 and extends backward from a lower end of the collar 73. The lower plate section 74 includes one or more lock portions 75 configured to be locked to the outer housing 3. Furthermore, in the present example, the two openings 62 are formed in a portion of the collar 73 which is located below the body section 60. Moreover, the lower plate section 74 includes openings which are connected continuously to the respective openings 62.

Each of the spring accommodating chambers 66 accommodates a backward half of the spring 16. The spring accommodating chambers 66 are provided on right and left faces of the body section 60 and connected to these faces.

The upper plate section 67 is arranged above the body section 60. The upper plate section 67 includes protrusions 68 and a lock portion 69, the protrusions 68 being placed in respective through-holes 38 in the outer housing 3 as described below, wherein the lock portion 69 is configured to be locked to the lock portion 89 of the male housing 8.

Directional terms such as “below the body section 60”, “above the body section 60”, “right and left faces of the body section 60” as used above are used merely for better understanding structural features of the invention, wherein the terms are used with respect to the orientation of the drawing plane. Therefore, the directional terms as used above may not necessarily coincide with those in actual use of the female connector 11.

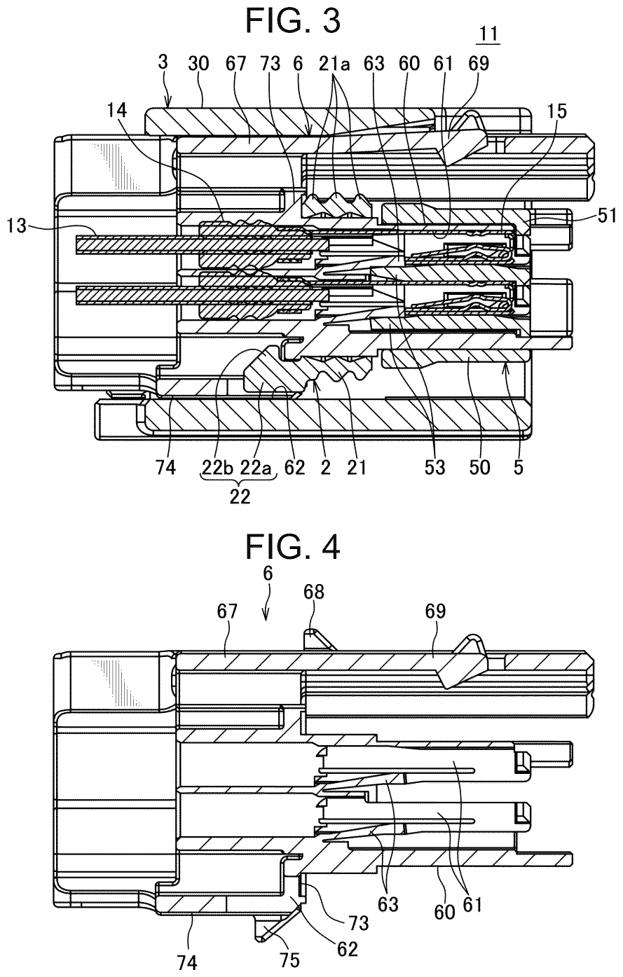

The front retainer 5 consists of an insulating resin. As shown in FIGS. 2 and 3, the front retainer 5 includes a forward wall 51, a peripheral wall 50, a limiting section 53 which are formed integrally, the forward wall 51 being positioned in front of a forward end face 60a of the body section 60, wherein the peripheral wall 50 surrounds an outer periphery of the body section 60, and the limiting section 53 is arranged inside the peripheral wall 50 and limits bending of the lance 63.

After the female terminals 15 have been inserted into the respective female terminal accommodating chambers 61 and each of the lances 63 has been locked to the female terminal 15, the limiting section 53 is positioned in a bending space of the lances 63 as shown in FIG. 3 to limit bending of the lances 63. In this manner, a locked state of the lances 63 is maintained in which are locked to the female terminals 15, whereby removal of the female terminals 15 is prevented.

The front retainer 5 is attached to the body section 60 so as to be movable forward and backward between a permitting position and a limiting position, wherein in the permitting position, the limiting section 53 permits the lances 63 to be bent, wherein in the limiting position, the limiting section 53 limits bending of the lances 63.

The outer housing 3 consists of an insulating resin. The outer housing 3 includes an outer housing body section 30 and one or more spring accommodating chambers 36 integrally, wherein the outer housing body section 30 is formed in a tubular shape and accommodates the female housing 6.

The outer housing body section 30 positions the tubular section 80 of the male housing 8 and the packing 2 between the outer housing body section 30 and the body section 60. The outer housing body section 30 has through-holes 38 and a lock hole 35 formed therein, the protrusions 68 of the female housing 6 being placed in the respective through-holes 38, wherein the lock hole 35 is configured for locking the lock portions 75 and 85 of the female housing 6 and the male housing 8 therein.

The spring accommodating chambers 36 accommodate forward halves of the springs 16. The female housing 6 is biased backward against the outer housing 3 by the springs 16 which are accommodated with their forward halves in the spring accommodating chambers 36 of the outer housing 3 and accommodated with backward halves of the springs 16 in the spring accommodating chambers 66 of the female housing 6.

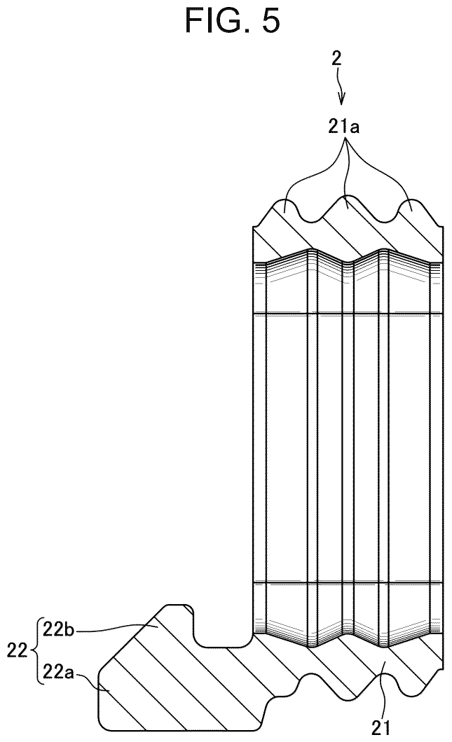

As shown in FIGS. 2 and 5, the packing 2 includes an annular section 21 and two locked sections 22 connected to the annular section 21. The two locked sections 22 are spaced from each other along a peripheral direction of the annular section 21.

The annular section 21 is attached to the outer peripheral surface of the body section 60 and to the forward side of the collar 73. The annular section 21 includes a lip portion 21a formed on an outer peripheral surface of the annular section 21. The annular section 21 is collapsed between the outer peripheral surface of the body section 60 and an inner peripheral surface of the tubular section 80 and thus elastically deformed to provide seal between the outer peripheral surface of the body section 60 and the inner peripheral surface of the tubular section 80.

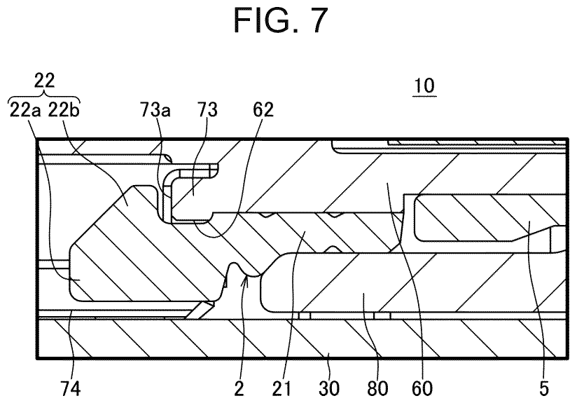

Each of the locked sections 22 is locked to one of the openings 62 of the collar 73. Each of the locked sections 22 includes an inserted portion 22a and a protrusion 22b, wherein the inserted portion 22a extends backward from a backward end of the annular section 21 and is inserted into the opening 62, wherein the protrusion 22b protrudes inward into the annular section 21 from a backward end of the inserted portion 22a (in a direction toward the body section 60). As shown in FIG. 7, each of the protrusions 22b is positioned on a backward side of the collar 73 and oriented toward a backward face 73a of the collar 73.

Such a packing 2 is attached to the female housing 6 from the forward side of the body section 60 before the front retainer 5 is attached to the body section 60. After the packing 2 has been attached to the female housing 6, the front retainer 5 is attached to the permitting position of the body section 60. In this state, the female terminals 15 are inserted into the female terminal accommodating chambers 61, wherein the lances 63 are then locked to the female terminals 15, and thereafter, the front retainer 5 is displaced to the limiting position of the body section 60.

The outer housing body section 30 is in contact with the lower end of the collar 73 and the lower plate section 74. This means that the outer housing body section 30 positions the inserted portions 22a between the outer housing body section 30 and inner surfaces of the openings 62. As shown in FIG. 10, a clearance between the inserted portion 22a and the outer housing body section 30 has a clearance dimension G which is smaller than a protruding length W of the protrusion 22b. The protruding length W of the protrusion 22b extending from the inserted portion 22a corresponds to an extension of engagement of the protrusion 22b with the collar 73 (edge of the opening 62), namely, this extension of engagement W is greater than the clearance dimension G.

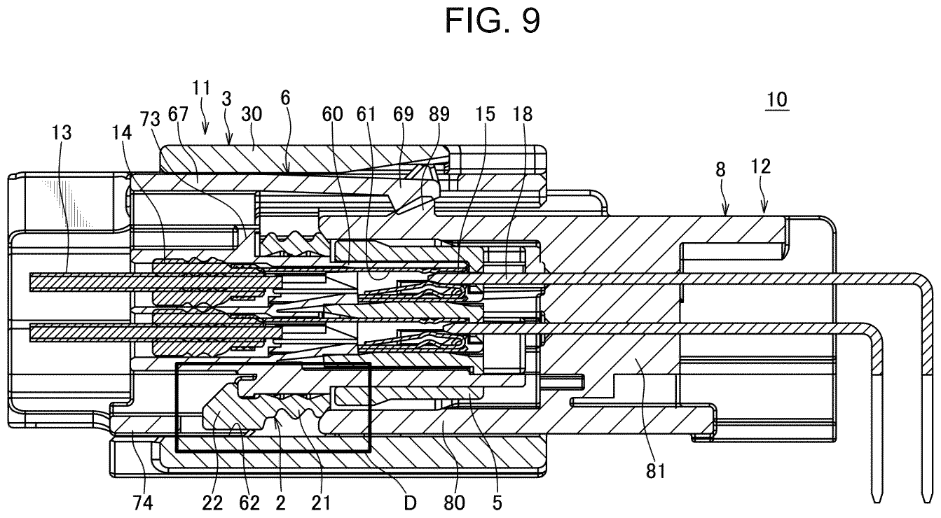

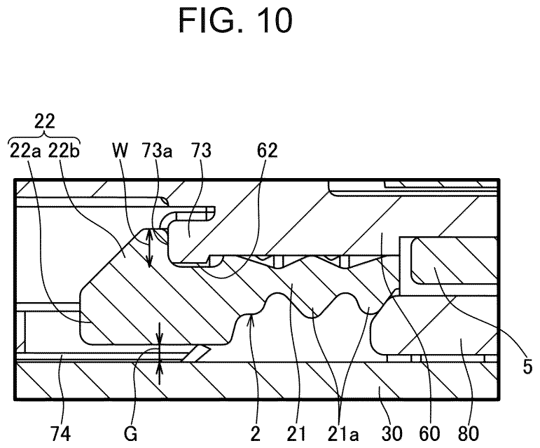

As shown in FIGS. 9 and 10, during removal operation for releasing a mated state of the male connector 12 and female connector 11, a friction force is generated by the tubular section 60 and the annular section 21, wherein the packing 2 is pulled in a removal direction by the friction force. However, the protrusion 22b is caught by the backward face 73a of the collar 73 (edge of the opening 62) during the pulling process of the packing 2, which prevents the locked section 22 from being removed from the opening 62. Furthermore, the clearance dimension G is smaller than the protruding length W of the protrusion 22b, which enables a locked state of the locked sections 22 to the openings 62 to be reliably maintained.

In this manner, the connector mating structure 10 enables the packing 2 to be prevented from being removed from the female housing 6 and/or misaligned.

It is to be noted that the embodiments as described above merely illustrate representative examples for the present invention, and the present invention is not limited to these embodiments. I.e., various modifications may be performed without departing from the core of the present invention. It is obvious that such modifications are included in the scope of the present invention as far as the modifications comprise the features of the present invention.

### REFERENCE SIGNS LIST

2 Packing
6 Female housing
8 Male housing
10 Connector mating structure
11 Female connector
12 Male connector
15 Female terminals
18 Male terminals
21 Annular section
22 Locked sections
60 Body section
62 Openings
73 Collar
80 Tubular section

What is claimed is:

1. A connector mating structure comprising:
a male connector and a female connector configured to be mated with each other,
wherein the male connector includes a male terminal and a male housing,
wherein the male housing includes a tubular section surrounding one end of the male terminal,
wherein the female connector includes a female terminal, a female housing and a packing,
wherein the female housing includes a body section and a collar,
wherein the body section is configured to accommodate the female terminal and includes a forward half, the forward half being configured to be inserted into the tubular section,
wherein the collar extends outward from an outer peripheral surface of the body section has an opening,
wherein the packing includes an annular section and a locked section,
wherein the annular section is configured to be attached to the outer peripheral surface of the body section and to a forward side of the collar to provide seal between the outer peripheral surface of the body section and an inner peripheral surface of the tubular section, and
wherein the locked section is connected to the annular section and locked to the opening.

2. The connector mating structure according to claim 1,
wherein the locked section includes an inserted portion and a protrusion,
wherein the inserted portion extends backward from a backward end of the annular section and is inserted into the opening,
wherein the protrusion protrudes inward into the annular section from a backward end of the inserted portion and is positioned on a backward side of the collar.

3. The connector mating structure according to claim 2,
wherein the female connector includes an outer housing configured to accommodate the female housing and to position the tubular section and the packing between the body section and the outer housing.

4. The connector mating structure according to claim 3,
wherein the opening is open on three sides of the collar, i.e., a forward side, backward side and a side of the collar facing the outer housing,
wherein the outer housing positions the inserted portion between the outer housing and the collar, and
wherein a clearance between the inserted portion and the outer housing has a clearance dimension which is smaller than a protruding length of the protrusion.
